(19) United States
(12) Patent Application Publication
(10) Pub. No.: US 2026/0336275 A1
(43) Pub. Date: Oct. 29, 2026

(54) SCREEN MASK SUPPORT FRAME AND PRINTER

(71) Applicant: FUJI CORPORATION, Chiryu (JP)

(72) Inventors: Yoshimune YOKOI, Kiyosu-shi (JP); Kentaro IKEDA, Toyota-shi (JP)

(73) Assignee: FUJI CORPORATION, Chiryu (JP)

(21) Appl. No.: 19/135,898

(22) PCT Filed: Dec. 19, 2022
(86) PCT No.: PCT/JP2022/046609

§ 371 Date: Jun. 5, 2025

(51) Int. Cl. B41F 15/36

(52) U.S. Cl. CPC B41F 15/36

(57) ABSTRACT

A screen mask support frame is for use in a printer configured to print viscous fluid on a target object using a screen mask with a mask main body fixed to an outer frame includes a frame member; a pair of first mask support to support first two sides, which face each other, of the outer frame in the screen mask; and the pair of second mask support portions provided on inner sides of second two sides orthogonal to the first two sides in the frame member, the pair of second mask support portions to support second two sides orthogonal to the first two sides of the outer frame in the screen mask, in which an interval between the pair of first mask support portions and an interval between the pair of second mask support portions are adjustable.

TECHNICAL FIELD

The present description discloses a screen mask support frame and a printer.

### BACKGROUND ART

Conventionally, a support frame for use in a printing device configured to print solder on a board and holds a screen mask is known. For example, Patent Literature 1 discloses a device that supports a screen mask via an elastic support member.

### CITATION LIST

### Patent Literature

Patent Literature 1: JP-A-H3-227241

### BRIEF SUMMARY

### Technical Problem

However, in the support frame described above, the elastic member is fixed to the support frame, and it is not possible to attach multiple screen masks having different sizes.

A main object of the present disclosure is to make it possible to support multiple screen masks having different sizes.

The present disclosure employs the following means in order to achieve the object described above.

### SOLUTION TO PROBLEM

A screen mask support frame according to the present disclosure is a screen mask support frame for use in a printer configured to print viscous fluid on a target object using a screen mask with a mask main body fixed to an outer frame, the screen mask support frame being for supporting the screen mask smaller than a size disposable in the printer, the screen mask support frame including:
a frame member having a size disposable in the printer;
a pair of first mask support portions provided on inner sides of first two sides, which face each other, in the frame member, the pair of first mask support portions being configured to support first two sides, which face each other, in the outer frame of the screen mask; and
a pair of second mask support portions provided on inner sides of second two sides orthogonal to the first two sides in the frame member, the pair of second mask support portions being configured to support second two sides orthogonal to the first two sides of the outer frame in the screen mask,
in which an interval between the pair of first mask support portions and an interval between the pair of second mask support portions are adjustable.

In the screen mask support frame, a width between the first mask support portions and a width between the second mask support portions are adjustable. Therefore, it is possible to make it possible to support multiple screen masks having different sizes.

A printer according to the present disclosure is a printer for printing viscous fluid on a target object using a screen mask with a mask main body fixed to an outer frame, the printer including:

a pair of rails extending in a printing region;
a screen mask supported by a screen mask support frame including a frame member having a size disposable in the pair of rails, a pair of first mask support portions provided on inner sides of first two sides, which face each other, in the frame member, the pair of first mask support portions being configured to support first two sides, which face each other, in the outer frame of the screen mask, and a pair of second mask support portions provided on inner sides of second two sides orthogonal to the first two sides in the frame member, the pair of second mask support portions being configured to laterally support second two sides orthogonal to the first two sides of the outer frame in the screen mask, in which an interval between the pair of first mask support portions and an interval between the pair of second mask support portions are adjustable;
a detection sensor configured to detect presence or absence of an interfering object between the pair of rails;
a contact section disposed above the pair of rails;
a lifting and lowering section configured to lift and lower the contact section;
a moving section configured to move the contact section along an extending direction of the pair of rails; and
a control section configured to control the lifting and lowering section such that the contact section is lowered, in a state in which an interfering portion of the screen mask support frame is not detected below the contact section by the detection sensor, and then control the moving section such that the contact section moves in the extending direction, in a state in which the contact section has been lowered.

In the printer, it is possible to use multiple screen masks having different sizes in the printer in accordance with the screen mask support frame. Further, it is possible to convey the screen mask support frame, to which the screen mask is attached, with the contact section by bringing the contact section into contact with the screen mask support frame at an appropriate position.

### BRIEF DESCRIPTION OF DRAWINGS

FIG. 1 is a perspective view of printer 10 and accommodation rack 60.

FIG. 2 is a side view of printer 10 and accommodation rack 60.

FIG. 3 is a perspective view of pusher 34 and screen mask M supported by screen mask support frame 80.

FIG. 4 is a perspective view showing a state in which screen mask M is attached to screen mask support frame 80.

FIG. 5 is a perspective view of screen mask support frame 80.

FIG. 6 is an exploded perspective view of screen mask support frame 80.

FIG. 7A is a cross-sectional view of first lower surface support member 83 attached to first side portion 81a via spacer 85 having a small width.

FIG. 7B is a cross-sectional view of first lower surface support member 83 attached to first side portion 81a via spacer 85 having a large width.

FIG. 8 is a side view of side surface support member 90.

FIG. 9 is a perspective view of first pressing member 94a.

FIG. 10 is a cross-sectional view when pressing member main body 95 of first pressing member 94a is positioned at advanced position R2.

FIG. 11A is a side view showing a state in which an interfering object is not detected by interfering object detection sensor 39.

FIG. 11B is a side view showing a state in which an interfering object is detected by interfering object detection sensor 39.

FIG. 12 is a block diagram showing an electrical connection relationship of printer 10.

FIG. 13 is a flowchart showing an example of a support frame exchanging process routine.

### DESCRIPTION OF EMBODIMENTS

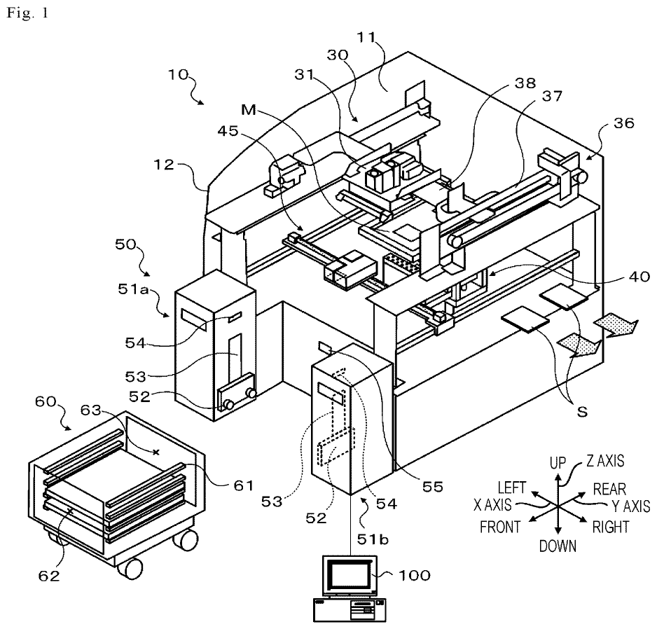

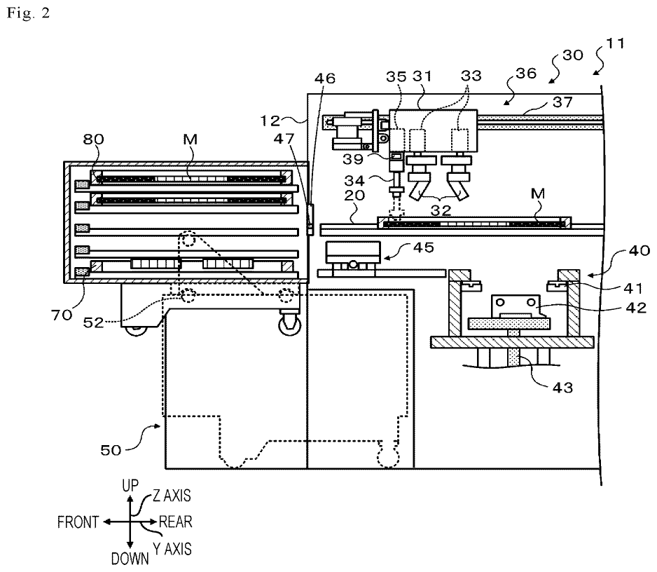

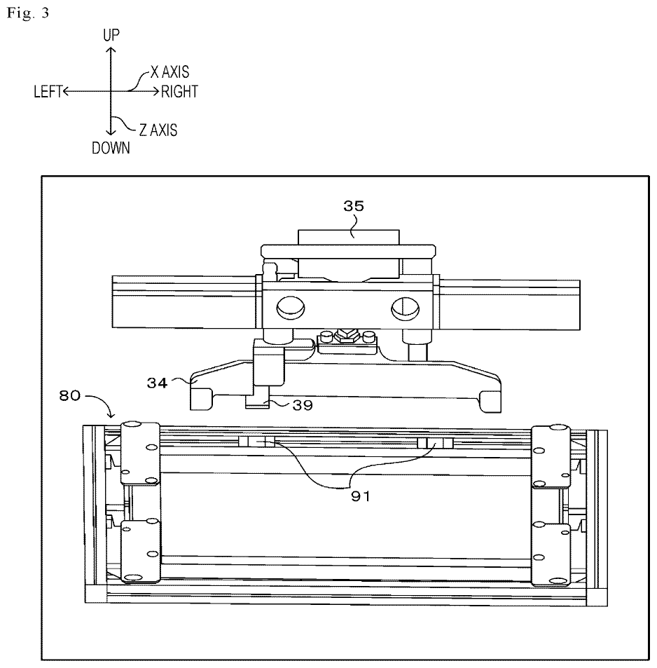

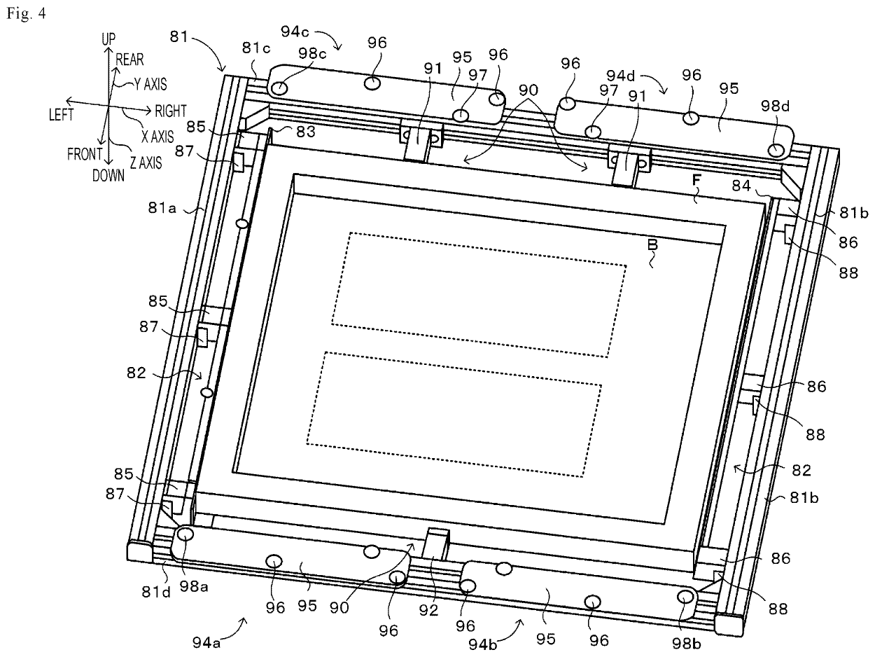

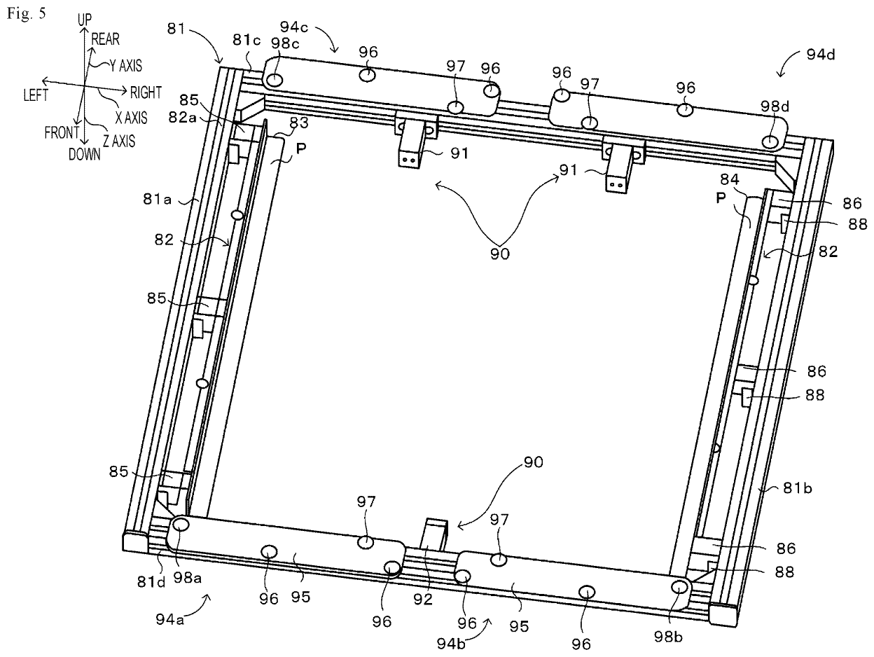

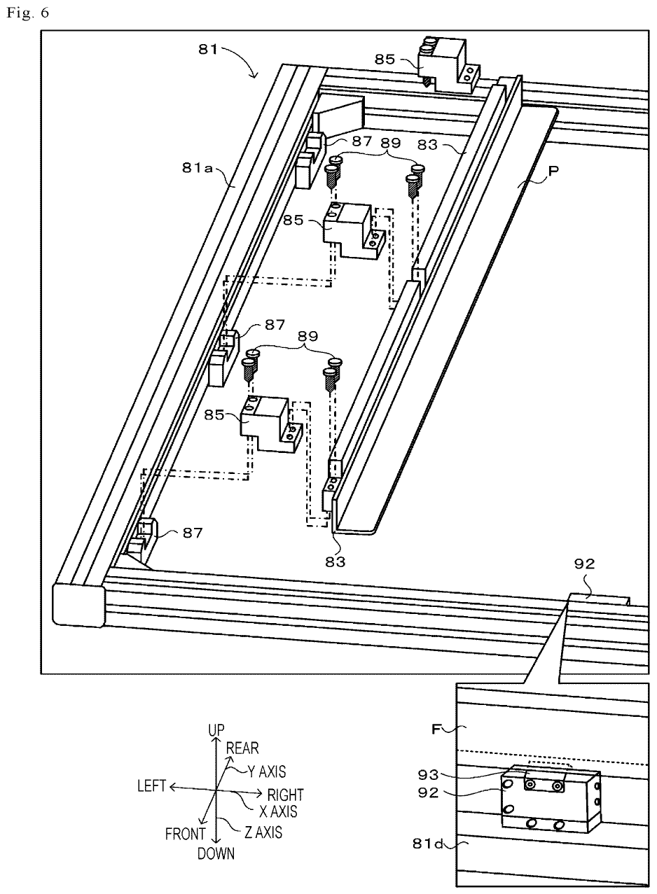

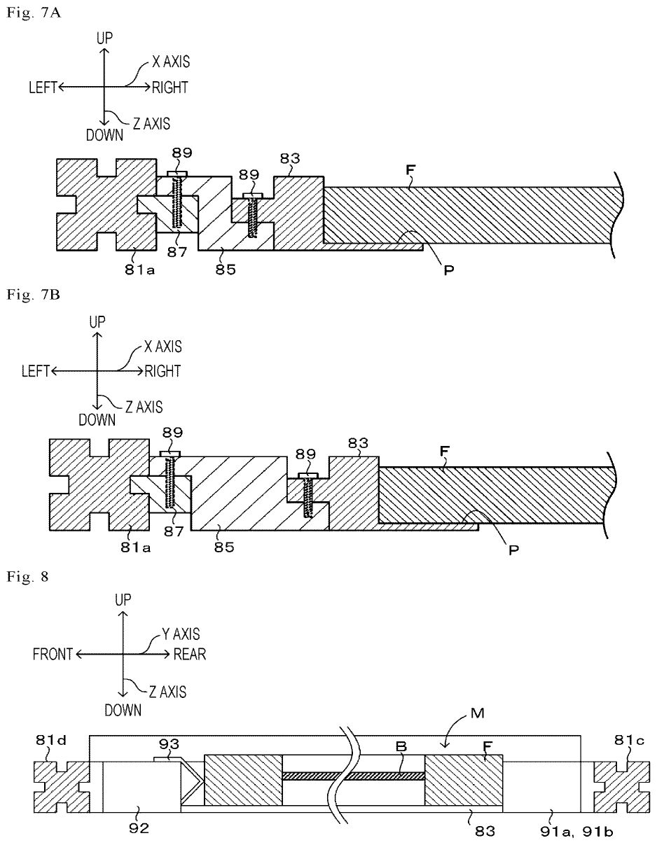

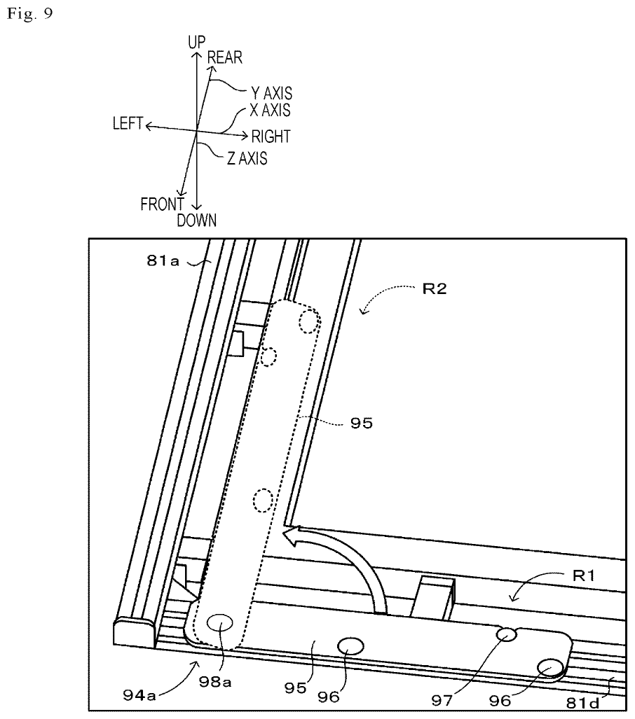

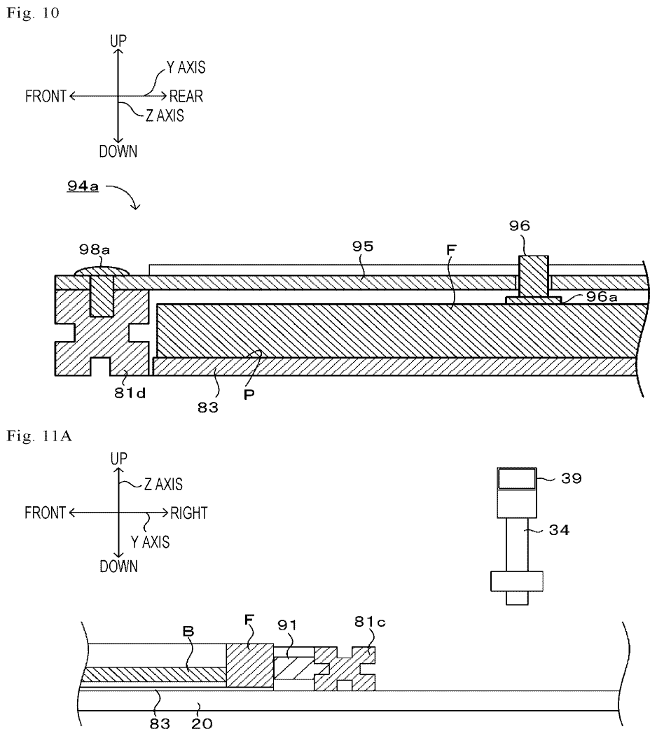

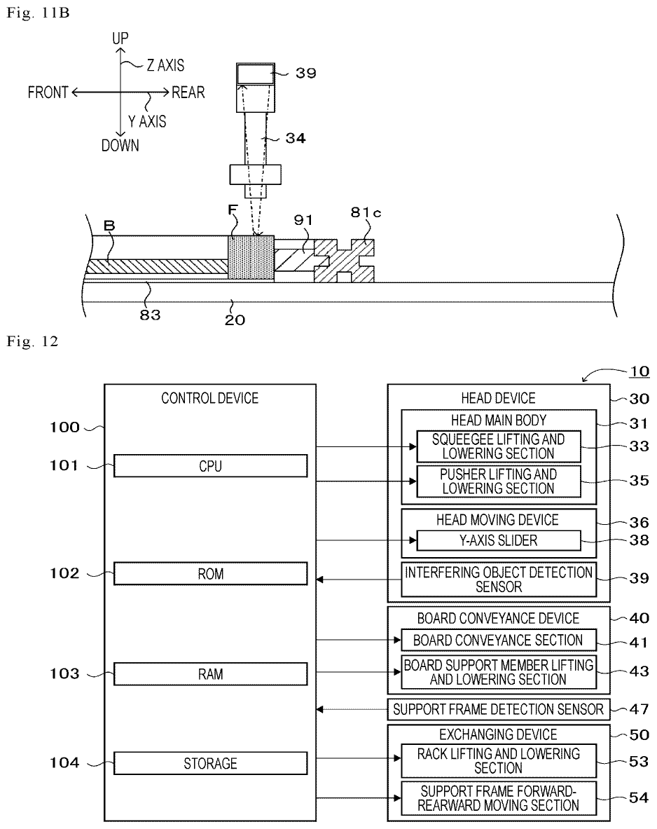

Next, an embodiment of the present disclosure will be described with reference to the accompanying drawings. FIG. 1 is a perspective view of printer 10 and accommodation rack 60. FIG. 2 is a side view of printer 10 and accommodation rack 60. FIG. 3 is a perspective view of pusher 34 and screen mask M supported by screen mask support frame 80. FIG. 4 is a perspective view showing a state in which screen mask M is attached to screen mask support frame 80. FIG. 5 is a perspective view of screen mask support frame 80. FIG. 6 is an exploded perspective view of screen mask support frame 80. FIG. 7A is a cross-sectional view of first lower surface support member 83 attached to first side portion 81a via spacer 85 having a small width. FIG. 7B is a cross-sectional view of first lower surface support member 83 attached to first side portion 81a via spacer 85 having a large width. FIG. 8 is a side view of side surface support member 90. FIG. 9 is a perspective view of first pressing member 94a. FIG. 10 is a cross-sectional view when pressing member main body 95 of first pressing member 94a is positioned at advanced position R2. FIG. 11A is a side view showing a state in which an interfering object is not detected by interfering object detection sensor 39. FIG. 11B is a side view showing a state in which an interfering object is detected by interfering object detection sensor 39. FIG. 12 is a block diagram showing an electrical connection relationship of printer 10. In FIGS. 1 to 11B, a left-right direction is an X axis (a direction perpendicular to the paper surface in FIGS. 2, 8, 10, 11A, and 11B), a front-rear direction is a Y axis (a direction perpendicular to the paper surface in FIGS. 7A and 7B), and an up-down direction is a Z axis.

Printer 10 according to the present embodiment prints solder on board S using screen mask M in a state of being supported by screen mask support frame 80, and constitutes a production line in combination with a component mounter that mounts electronic components on board S on which solder is printed. As shown in FIGS. 1 and 2, printer 10 includes printer main body 11, housing 12 that accommodates printer main body 11, exchanging device 50, accommodation rack 60, screen mask M, interfering object detection sensor 39, and control device 100 that controls entire printer 10. Printer main body 11 includes pair of left and right conveyance rails 20, head device 30, and board conveyance device 40.

Pair of conveyance rails 20 is used to convey screen mask M. As shown in FIG. 2, conveyance rails 20 are a pair of left and right long rails that is installed at substantially the same height as passage opening 46 provided on a front surface of a middle-stage portion of housing 12 and extends in the front-rear direction (Y-axis direction). Conveyance rails 20 are also used to convey a conveyance jig to which an exchange member is attached to exchange an exchange member such as squeegee 32 or board support member 42 described later.

Head device 30 is installed in an upper-stage portion of housing 12 (above conveyance rails 20). As shown in FIG. 2, head device 30 includes head main body 31 and head moving section 36 that moves head main body 31 in the front-rear direction (Y-axis direction) that is a printing direction.

As shown in FIG. 2, head main body 31 includes pair of front and rear squeegees 32, squeegee lifting and lowering sections 33 that include, for example, an air cylinder and lift and lower corresponding squeegee 32, pusher 34, and pusher lifting and lowering section 35.

Pair of squeegees 32 prints a solder paste on board S below via pattern holes formed in screen mask M by pressing the solder paste on screen mask M into the pattern holes. Pair of squeegees 32 is plate-shaped members extending in the left-right direction (X-axis direction) orthogonal to the printing direction. Pair of squeegees 32 is inclined to be separated from each other as extending downward when viewed from the left-right direction.

Pusher 34 is used to convey screen mask M. Pusher 34 is held by head main body 31 to be positioned above a space between pair of conveyance rails 20. As shown in FIG. 3, pusher 34 is a plate-shaped member extending in the left-right direction (X-axis direction). Pusher lifting and lowering section 35 moves pusher 34 in the up-down direction (Z-axis direction). Pusher lifting and lowering section 35 includes, for example, an air cylinder.

Head moving section 36 moves head main body 31 in the front-rear direction (Y-axis direction). As shown in FIG. 1, head moving section 36 includes guide rail 37 extending in the front-rear direction, Y-axis slider 38 that moves along guide rail 37, and a motor (not shown) that drives Y-axis slider 38. Pusher 34 is moved forward and rearward by head moving section 36 in a state of being lowered by pusher lifting and lowering section 35, so that pusher 34 comes into contact with an outer surface or an inner surface of third side portion 81c or fourth side portion 81d, which will be described later, of screen mask support frame 80 on conveyance rails 20 and pushes and moves screen mask support frame 80 forward and rearward. As shown in FIG. 2, screen mask support frame 80 moves into and out of housing 12 through passage opening 46 provided in the front surface of the middle-stage portion of housing 12. Passage opening 46 is provided with support frame detection sensor 47 that detects passage of screen mask support frame 80.

Board conveyance device 40 conveys in, positions, and supports board S, and brings board S into contact with and separates from screen mask M (rear surface). Board conveyance device 40 is installed in a lower-stage portion of housing 12 (below conveyance rails 20). As shown in FIG. 2, board conveyance device 40 includes board conveyance section 41 that conveys board S in the left-right direction (X-axis direction), board support member 42 as a backup member that supports board S from below, and board support member lifting and lowering section 43 that lifts and lowers board support member 42. Board conveyance section 41 includes a pair of front and rear conveyor belts, and conveys board S by driving the pair of conveyor belts. An interval between the pair of conveyor belts in the front-rear direction is adjusted in accordance with a size of board S to be conveyed. Board support member 42 is exchanged with one of a size suitable for supporting board S in accordance with the size of board S.

Exchanging device 50 receives accommodation rack 60 that accommodates an exchange member (such as screen mask M or board support member 42) used in printer main body 11, and conveys the exchange member between accommodation rack 60 and printer main body 11. In accommodation rack 60, screen mask M is accommodated in a state of being supported by screen mask support frame 80, and board support member 42 is accommodated in a state of being attached to a conveyance jig (not shown). Exchanging device 50 includes left unit 51a installed on a left side on a front surface of printer main body 11 and right unit 51b installed on a right side on the front surface of printer main body 11. Left unit 51a and right unit 51b include rack support member 52 that receives accommodation rack 60 and supports a lower surface of accommodation rack 60 from both left and right sides, and rack lifting and lowering section 53 that lifts and lowers rack support member 52. Rack lifting and lowering section 53 includes, for example, a combination of a ball screw mechanism and a motor, or a linear motor. Accommodation rack 60 supported by rack support member 52 is lifted and lowered together with rack support member 52 by rack lifting and lowering section 53. Furthermore, left unit 51a and right unit 51b have support frame forward-rearward moving section 54 that sends screen mask support frame 80 and the conveyance jig in accommodation rack 60 forward and rearward from both left and right side surfaces with a belt, a roller, or the like.

As shown in FIG. 1, accommodation rack 60 is an accommodating body having pairs of left and right support rails 61 in multiple stages in the up-down direction and is capable of accommodating the exchange member in each support rail 61. Openings 62 and 63 are formed in front and rear surfaces of accommodation rack 60. The exchange member is taken in and out by a worker or the like through opening 62 on a front surface side, and is conveyed in and out by support frame forward-rearward moving section 54 through opening 63 on a rear surface side. In a state in which accommodation rack 60 is received by exchanging device 50, support frame forward-rearward moving section 54 feeds the exchange member that is supported on support rails 61 positioned at substantially the same height as conveyance rails 20 of printer main body 11 among support rails 61 in multiple stages in accommodation rack 60, to printer main body 11. Support frame forward-rearward moving section 54 feeds the exchange member supported on conveyance rails 20 of printer main body 11 to support rails 61 of accommodation rack 60 positioned at substantially the same height as conveyance rails 20. Accommodation rack 60 may be conveyed to a receiving position of exchanging device 50 by the worker, or may be mounted on an automated guided vehicle (AGV) and automatically conveyed to the receiving position of exchanging device 50 by the automated guided vehicle.

Screen mask M is used to print solder on board S below via the pattern holes by pressing the solder into the pattern holes, using squeegee 32. Screen mask M includes outer frame F and mask main body B fixed to outer frame F. Mask main body B is a thin metal plate. Screen mask M is positioned and fixed at a work position (printing region) on conveyance rails 20 in a state of being supported by screen mask support frame 80, and is used to print solder.

Screen mask support frame 80 supports screen mask M. As shown in FIGS. 5 and 6, screen mask support frame 80 includes frame member 81, lower surface support member 82 (first lower surface support member 83, second lower surface support member 84), side surface support member 90 (first side surface support members 91 and 91, second side surface support member 92), and pressing member 94 (first to fourth pressing members 94a to 94d). Frame member 81 has four rectangular sides. Frame member 81 includes first side portion 81a and second side portion 81b extending in the front-rear direction (Y-axis direction) in parallel to each other, third side portion 81c extending in the left-right direction (X-axis direction) and connecting first end portions of first side portion 81a and second side portion 81b, and fourth side portion 81d extending in the left-right direction (X-axis direction) and connecting second end portions of first side portion 81a and second side portion 81b. A dimension of first side portion 81a and second side portion 81b in the front-rear direction (Y-axis direction) is a length that covers a maximum range in the front-rear direction in which printing is possible and that corresponds to an interval between pair of conveyance rails 20. A dimension of third side portion 81c and fourth side portion 81d in the left-right direction (X-axis direction) is a length that covers a maximum range in the left-right direction in which printing is possible.

As shown in FIGS. 4 to 10, lower surface support member 82 is fixed to each of first side portion 81a and second side portion 81b of frame member 81, and supports, from below, two sides extending in the front-rear direction (Y-axis direction) in outer frame F of screen mask M. Lower surface support member 82 includes first lower surface support member 83 that places a first one of the two sides of outer frame F extending in the front-rear direction on placement surface P, and second lower surface support member 84 that places a second one of the two sides on placement surface P. As shown in FIGS. 4 and 5, in the present embodiment, first lower surface support member 83 is attached to a right side surface of first side portion 81a in the drawing via spacer 85. In the present embodiment, second lower surface support member 84 is attached to a left side surface of second side portion 81b in the drawing via spacer 86. Further, as shown in FIG. 6, spacer 85 is fixed to bracket 87 fixed to first side portion 81a at a left end portion in the left-right direction in the drawing by attachment screw 89, and is fixed to first lower surface support member 83 at a right end portion by attachment screw 89. Similarly, spacer 86 is fixed to bracket 88 fixed to second side portion 81b at a right end portion in the left-right direction by attachment screw 89, and is fixed to second lower surface support member 84 at a left end portion by attachment screw 89. In screen mask support frame 80, as shown in FIGS. 7A and 7B, multiple spacers 85 and 86 having various sizes (lengths) in the left-right direction are prepared in advance, and first lower surface support member 83 and second lower surface support member 84 can be attached by selecting a spacer having a desired size from multiple spacers 85 and 86. Accordingly, an interval between first lower surface support member 83 and second lower surface support member 84 in the left-right direction (X-axis direction) can be adjusted. Therefore, screen mask M (outer frame F) having various widths in the left-right direction can be placed on screen mask support frame 80.

Side surface support member 90 supports two sides extending in the left-right direction (X-axis direction) in outer frame F of screen mask M from side surfaces. As shown in FIGS. 4 and 5, side surface support member 90 has multiple (two) first side surface support members 91 and 91 that support a side surface of a first one of two sides extending in the left-right direction in outer frame F of screen mask M, and second side surface support member 92 that supports a side surface of a second one of the two sides. First side surface support members 91 and 91 are fixed to a front side surface of third side portion 81c by an attachment screw (not shown) at a predetermined interval in the left-right direction. Meanwhile, second side surface support member 92 is fixed to substantially a center of a rear side surface of fourth side portion 81d by an attachment screw (not shown). First side surface support members 91 and 91 and second side surface support member 92 are rectangular parallelepiped members. As shown in FIGS. 6 and 8, leaf spring 93 is attached to a surface of second side surface support member 92. Outer frame F of screen mask M is biased from second side surface support member 92 to first side surface support members 91 and 91 by an elastic force of leaf spring 93, and is pressed against first side surface support members 91 and 91. Accordingly, screen mask M (outer frame F) is positioned in the front-rear direction with respect to screen mask support frame 80. In screen mask support frame 80, first side surface support members 91 and 91 and second side surface support member 92 having various lengths in the front-rear direction are prepared in advance, and a side surface support member having a desired size can be selected for exchanging from multiple first side surface support members 91 and 91 and multiple second side surface support members 92. Accordingly, an interval between first side surface support members 91 and 91 and second side surface support member 92 in the front-rear direction (Y-axis direction) can be adjusted. Therefore, screen mask support frame 80 can support and position screen mask M (outer frame F) having various widths in the front-rear direction.

First to fourth pressing members 94a to 94d press screen mask M against placement surface P of lower surface support member 82 to prevent screen mask M from floating. As shown in FIGS. 4 and 5, first pressing member 94a is provided at a left front corner of frame member 81 to be rotatable about rotation shaft 98a. Second pressing member 94b is provided at a right front corner of frame member 81 to be rotatable about rotation shaft 98b. Third pressing member 94c is provided at a left rear corner of frame member 81 to be rotatable about rotation shaft 98c. Fourth pressing member 94d is provided at a right rear corner of frame member 81 to be rotatable about rotation shaft 98d. As shown in FIGS. 4, 5, 9, and 10, first to fourth pressing members 94a to 94d include pressing member main body 95, pressing screw 96, and fixing screw 97. Pressing member main body 95 is a plate-shaped member having a length equal to or less than half of first side portion 81a and second side portion 81b and equal to or less than half of third side portion 81c and fourth side portion 81d. As shown in FIG. 9, pressing member main bodies 95 of first to fourth pressing members 94a to 94d are rotatable in a horizontal direction about corresponding rotation shafts 98a to 98d between retracted position RI retracted from an inside of frame member 81 and advanced position R2 advanced to the inside of frame member 81. Here, as shown in FIG. 5, retracted position R1 is a position where pressing member main body 95 overlaps corresponding third and fourth side portions 81c and 81d. Meanwhile, advanced position R2 is a position where pressing member main body 95 is rotated by 90° from retracted position RI toward the inside of frame member 81.

Pressing screws 96 are for pressing outer frame F of screen mask M against placement surfaces P of first lower surface support member 83 and second lower surface support member 84. Pressing screw 96 is configured as, for example, a knurled screw, and as shown in FIG. 10, flange 96a (pressing surface) is formed at a lower end portion. When pressing screw 96 is tightened in a state in which screen mask M is placed on first lower surface support member 83 and second lower surface support member 84 and pressing member main body 95 is advanced to advanced position R2, a lower surface of flange 96a comes into contact with outer frame F of screen mask M. When further tightened in this state, pressing screw 96 presses outer frame F of screen mask M against placement surface P of first lower surface support member 83 or second lower surface support member 84. Meanwhile, in a state in which pressing screw 96 is loosened and is not in contact with outer frame F, pressing screw 96 does not press outer frame F against placement surface P of first lower surface support member 83 or second lower surface support member 84.

Fixing screw 97 is for positioning pressing member main body 95. Fixing screw 97 is configured as, for example, a knurled screw, and as shown in FIG. 9, when fixing screw 97 is tightened in a state in which pressing member main body 95 is retracted to retracted position R1, pressing member main body 95 is fixed to frame member 81 (third side portion 81c or fourth side portion 81d), and pressing member main body 95 is positioned at retracted position R1. When fixing screw 97 is tightened in a state in which pressing member main body 95 is advanced to advanced position R2, pressing member main body 95 is fixed to first lower surface support member 83 or second lower surface support member 84, and pressing member main body 95 is positioned at advanced position R2. Meanwhile, when fixing screw 97 is loosened in a state in which pressing screw 96 is loosened, fixing screw 97 allows pressing member main body 95 to rotate about rotation shaft 98.

In screen mask support frame 80, the interval between first lower surface support member 83 and second lower surface support member 84 can be adjusted by changing dimensions of spacers 85 and 86 in the left-right direction (X-axis direction). In screen mask support frame 80, the interval between first side surface support members 91 and 91 and second side surface support member 92 can be changed by changing dimensions of first side surface support members 91 and 91 and second side surface support member 92 in the front-rear direction (Y-axis direction). Therefore, screen mask support frame 80 can support screen mask M having various dimensions. Screen mask support frame 80 includes pressing member 94 that presses outer frame F against placement surfaces P of first lower surface support member 83 and second lower surface support member 84. In screen mask support frame 80, second side surface support member 92 includes leaf spring 93 that presses outer frame F against first side surface support members 91 and 91. Therefore, screen mask support frame 80 can position and support screen mask M regardless of a tolerance of each member or the like.

Interfering object detection sensor 39 detects whether there is an interfering object (for example, third side portion 81c of frame member 81, first side surface support member 91, outer frame F, or the like) below pusher 34. In head main body 31, a position of interfering object detection sensor 39 in the front-rear direction (Y-axis direction) is the same as that of pusher 34, and a position in the left-right direction (X-axis direction) is provided at a position adjacent to pusher 34. As shown in FIG. 3, the position of interfering object detection sensor 39 in the left-right direction in head main body 31 is a position where first side surface support member 91 on the left side in the drawing can be detected. Interfering object detection sensor 39 is, for example, a reflective optical sensor including a light projecting element and a light receiving element (not shown). As shown in FIG. 11A, when the light emitted from the light projecting element is not reflected by an interfering object and is not received by the light receiving element, interfering object detection sensor 39 outputs, to control device 100, a signal indicating that an interfering object has not been detected. Meanwhile, as shown in FIG. 11B, when the light emitted from the light projecting element is reflected by an interfering object and received by the light receiving element, interfering object detection sensor 39 outputs, to control device 100, a signal indicating that the interfering object has been detected.

As shown in FIG. 12, control device 100 is a computer mainly including CPU 101, ROM 102, RAM 103, and storage (for example, an HDD or an SSD) 104. Control device 100 inputs detection signals from interfering object detection sensor 39, support frame detection sensor 47, and the like. In addition, control device 100 outputs control signals to squeegee lifting and lowering section 33, pusher lifting and lowering section 35, Y-axis slider 38, board conveyance section 41, board support member lifting and lowering section 43, rack lifting and lowering section 53, support frame forward-rearward moving section 54, and the like.

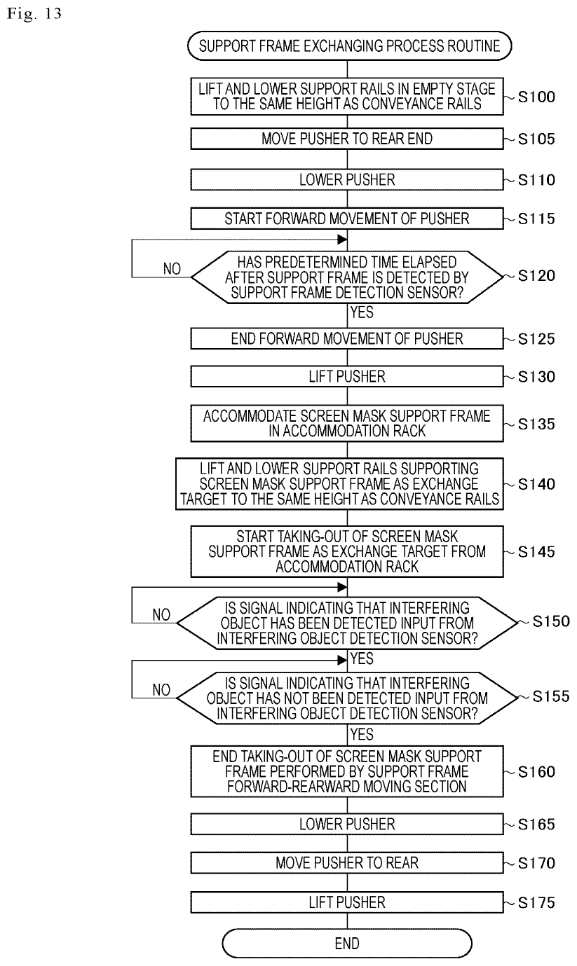

Next, an operation of printer 10 configured as described above will be described with reference to FIG. 13. In the present embodiment, a case where screen mask M is exchanged between printer main body 11 and accommodation rack 60 will be described as an example. The routine is performed by CPU 101 of control device 100, for example, when a type of a board to be produced is changed in the production line. In executing the routine, it is assumed that pusher 34 is positioned at an upper end in the up-down direction (Z-axis direction). Screen mask M is attached to screen mask support frame 80 in a state in which the four sides are supported by first lower surface support member 83, second lower surface support member 84, first side surface support members 91 and 91, and second side surface support member 92. In first lower surface support member 83 and second lower surface support member 84, spacers 85 and 86 having desired sizes are selected as spacers 85 and 86 for attaching first lower surface support member 83 and second lower surface support member 84 to frame member 81 so that the interval between first lower surface support member 83 and second lower surface support member 84 is an interval corresponding to the dimension of screen mask M in the left-right direction. In addition, in first and second side surface support members 91 and 92, first and second side surface support members 91 and 92 having desired sizes are selected so that the interval between first side surface support members 91 and 91 and second side surface support member 92 is an interval corresponding to the dimension of screen mask M in the front-rear direction.

When the routine is started, CPU 101 controls rack lifting and lowering section 53 such that positions of support rails 61 in an empty stage in accommodation rack 60 in the up-down direction (Z-axis direction) coincide with positions of conveyance rails 20 (S100). Next, CPU 101 controls Y-axis slider 38 such that pusher 34 moves to a rear end (S105). Subsequently, CPU 101 controls pusher lifting and lowering section 35 such that pusher 34 is lowered (S110). Then, CPU 101 controls Y-axis slider 38 such that pusher 34 starts forward movement in a state in which pusher 34 has been lowered (S115). When pusher 34 moves forward, pusher 34 comes into contact with the rear end (a rear side surface of third side portion 81c) of frame member 81 of screen mask support frame 80 and feeds screen mask support frame 80 forward.

Next, CPU 101 waits for a predetermined time to elapse after screen mask support frame 80 is detected by support frame detection sensor 47 provided at passage opening 46 of housing 12 (S120). Accordingly, screen mask support frame 80 moves to a position where screen mask support frame 80 can be accommodated in accommodation rack 60 by support frame forward-rearward moving section 54. In the process of S115, CPU 101 may control Y-axis slider 38 such that pusher 34 moves to a front end in the front-rear direction. In this case, the process of S120 is unnecessary. Subsequently, CPU 101 controls Y-axis slider 38 such that pusher 34 is stopped and the forward movement of screen mask M is ended (S125). Then, CPU 101 controls pusher lifting and lowering section 35 such that pusher 34 is lifted (S130).

Next, CPU 101 controls support frame forward-rearward moving section 54 such that screen mask support frame 80 is accommodated in accommodation rack 60 (S135). Subsequently, CPU 101 controls rack lifting and lowering section 53 such that the positions of support rails 61 supporting screen mask M (screen mask support frame 80) as an exchange target in the up-down direction (Z-axis direction) coincide with the positions of conveyance rails 20 (S140). Then, CPU 101 controls support frame forward-rearward moving section 54 such that screen mask support frame 80 is taken out from accommodation rack 60 (S145).

Next, CPU 101 waits until the signal indicating that an interfering object has been detected is input from interfering object detection sensor 39 (S150). After the process of S120, head main body 31 (pusher 34, interfering object detection sensor 39) stands by near the front end in the front-rear direction. Therefore, the process of S150 is for monitoring that a rear end portion of screen mask support frame 80 (third side portion 81c of frame member 81 and second side surface support member 91) and outer frame F of screen mask M (interfering object) pass through passage opening 46 from accommodation rack 60 and cross an optical axis of interfering object detection sensor 39. When the signal indicating that an interfering object has been detected is input from interfering object detection sensor 39, frame member 81 of screen mask support frame 80, first side surface support member 91, outer frame F of screen mask M, and the like are positioned below pusher 34. Subsequently, CPU 101 waits until the signal indicating that an interfering object has not been detected is input from interfering object detection sensor 39 (S155). When the signal indicating that the interfering object has been detected is no more input from interfering object detection sensor 39, frame member 81 of screen mask support frame 80, first side surface support member 91, outer frame F, and the like move to the rear of pusher 34, and do not interfere with pusher 34 even when pusher 34 is lowered. Then, CPU 101 controls support frame forward-rearward moving section 54 such that the taking-out of screen mask support frame 80 performed by support frame forward-rearward moving section 54 is ended (S160).

Next, CPU 101 controls pusher lifting and lowering section 35 such that pusher 34 is lowered (S165). Subsequently, CPU 101 controls Y-axis slider 38 such that screen mask support frame 80 that comes into contact with pusher 34 moves to the work position (printing region) (S170). Accordingly, pusher 34 comes into contact with outer frame F of screen mask M supported by screen mask support frame 80 from the inside. Then, screen mask M is pushed by pusher 34 and conveyed to the work position. Then, CPU 101 controls pusher lifting and lowering section 35 such that pusher 34 is lifted (S175), and ends the routine.

In printer 10, interfering object detection sensor 39 determines whether there is an interfering object that interferes with pusher 34 when pusher 34 is lowered, and pusher 34 is lowered to a position where pusher 34 does not interfere with the interfering object. Therefore, even when screen mask M having various sizes is attached to screen mask support frame 80, it is possible to convey screen mask M by bringing pusher 34 into contact with an appropriate position of screen mask M or screen mask support frame 80.

Here, a correspondence relationship between the elements of the present embodiment and the elements of the present disclosure will be clarified. Screen mask support frame 80 according to the present embodiment corresponds to a screen mask support frame according to the present disclosure, frame member 81 corresponds to a frame member, first lower surface support member 83 and second lower surface support member 84 correspond to first mask support portions, and two first side surface support members 91 and 91 and second side surface support member 92 correspond to second mask support portions. Spacers 85 and 86 correspond to a spacer. Placement surface P corresponds to a placement surface, and pressing member 94 (first to fourth pressing members 94a to 94d) corresponds to a pressing member. Leaf spring 93 corresponds to a biasing member. Further, printer 10 corresponds to a printer, conveyance rails 20 correspond to rails, screen mask M corresponds to a screen mask, interfering object detection sensor 39 corresponds to a detection sensor, pusher 34 corresponds to a contact section, pusher lifting and lowering section 35 corresponds to a lifting and lowering section, head moving section 36 corresponds to a moving section, and CPU 101 that executes the processes of S150 to S170 corresponds to a control section.

In screen mask support frame 80 described in detail above, the interval between first lower surface support member 83 and second lower surface support member 84 and the interval between first side surface support members 91 and 91 and second side surface support member 92 are adjustable. Therefore, it is possible to make it possible to support screen masks M having different sizes.

In screen mask support frame 80, lower surface support member 82 (first lower surface support member 83 and second lower surface support member 84) are attachable to first side portion 81a and second side portion 81b via spacers 85 and 86. Accordingly, it is possible to relatively easily adjust the interval between first lower surface support member 83 and second lower surface support member 84.

In screen mask support frame 80, lower surface support member 82 includes placement surface P on which two sides extending in the front-rear direction in outer frame F of screen mask M are placed, and pressing member 94 that is movable between advanced position R2 advanced to the inside of frame member 81 and retracted position R1 retracted from the inside of frame member 81 and presses outer frame F of screen mask M placed on placement surface P against placement surface P at advanced position R2. Accordingly, it is possible to support screen mask M in a stable state.

In screen mask support frame 80, first lower surface support member 83 and second lower surface support member 84 have placement surfaces P on which two sides extending in the front-rear direction in outer frame F of screen mask M are placed, and first side surface support members 91 and 91 and second side surface support member 92 are in contact with and support two side surfaces extending in the left-right direction (X-axis direction) in an outer frame of screen mask M. Accordingly, it is possible to support screen mask M in a stable state. Second side surface support member 92 is provided with leaf spring 93 that presses outer frame F of screen mask M from second side surface support member 92 toward first side surface support members 91 and 91. Accordingly, screen mask support frame 80 can position and support screen mask M regardless of the tolerance of each member or the like.

In the printer, it is possible to use multiple screen masks M having different sizes in the printer via screen mask support frame 80. Further, it is possible to, at an appropriate position, bring pusher 34 into contact with screen mask support frame 80 to which screen mask M is attached to convey screen mask support frame 80 with pusher 34.

The present disclosure is not limited in any way to the above-described embodiment, and the present disclosure can be embodied in various aspects as long as the various aspects fall within the technical scope of the present disclosure.

In the above-described embodiment, the printer according to the present disclosure is applied to a printer for printing solder as viscous fluid on board S as a target object. However, the target object may be another base material such as a three-dimensional object, and the viscous fluid may be a conductive paste, an adhesive, or the like.

In the above-described embodiment, only two first side surface support members 91 and 91 are provided on the front side surface of third side portion 81c. However, three or more first side surface support members may be provided, or only one first side surface support member may be provided.

In the above-described embodiment, only one second side surface support member 92 is provided substantially at the center of the rear side surface of fourth side portion 81d. However, two or more second side surface support members 92 may be provided.

In the above-described embodiment, leaf spring 93 is provided on second side surface support member 92. However, leaf spring 93 may be provided in first side surface support members 91 and 91.

In the above-described embodiment, first lower surface support member 83 and second lower surface support member 84 are attached to first side portion 81a and second side portion 81b via spacers 85 and 86, respectively. However, first lower surface support member 83 and second lower surface support member 84 may be directly attached to first side portion 81a and second side portion 81b without spacers 85 and 86, respectively. In this case, multiple first lower surface support members 83 and multiple second lower surface support members 84 having different sizes need only be prepared, and first lower surface support members 83 and second lower surface support members 84 need only be exchanged according to the size of outer frame F of screen mask M to adjust the interval between first lower surface support member 83 and second lower surface support member 84 in the left-right direction (X-axis direction).

### INDUSTRIAL APPLICABILITY

The present disclosure is applicable to a printer manufacturing industry and the like.

### REFERENCE SIGNS LIST

10: printer, 11: printer main body, 12: housing, 20: conveyance rail, 30: head device, 31: head main body, 32: squeegee, 33: squeegee lifting and lowering section, 34: pusher, 35: pusher lifting and lowering section, 36: head moving section, 37: guide rail, 38: Y-axis slider, 39: interfering object detection sensor, 40: board conveyance device, 41: board conveyance section, 42: board support member, 43: board support member lifting and lowering section, 46: passage opening, 47: support frame detection sensor, 50: exchanging device, 51a: left unit, 51b: right unit, 52: rack support member, 53: rack lifting and lowering section, 54: support frame forward-rearward moving section, 60: accommodation rack, 61: support rail, 62: opening, 63: opening, 80: screen mask support frame, 81: frame member, 81a: first side portion, 81b: second side portion, 81c: third side portion, 81d: fourth side portion, 82: lower surface support member, 83: first lower surface support member, 84: second lower surface support member, 85: spacer, 86: spacer, 87: bracket, 88: bracket, 89: attachment screw, 90: side surface support member, 91: first side surface support member, 92: second side surface support member, 93: leaf spring, 94: pressing member, 94a: first pressing member, 94b: second pressing member, 94c: third pressing member, 94d: fourth pressing member, 95: pressing member main body, 96: pressing screw, 96a: flange, 97: fixing screw, 98a, 98b, 98c, 98d: rotation shaft, 100: control device, 101: CPU, 102: ROM, 103: RAM, 104: storage, B: mask main body, F: outer frame, M: screen mask, P: placement surface, R1: retracted position, R2: advanced position, S: board.

1. A screen mask support frame for use in a printer configured to print viscous fluid on a target object using a screen mask with a mask main body fixed to an outer frame, the screen mask support frame being for supporting the screen mask smaller than a size disposable in the printer, the screen mask support frame comprising:
a frame member having a size disposable in the printer;
a pair of first mask support portions provided on inner sides of first two sides, which face each other, in the frame member, the pair of first mask support portions being configured to support first two sides, which face each other, of the outer frame in the screen mask; and
a pair of second mask support portions provided on inner sides of second two sides orthogonal to the first two sides in the frame member, the pair of second mask support portions being configured to support second two sides orthogonal to the first two sides of the outer frame in the screen mask,
wherein an interval between the pair of first mask support portions and an interval between the pair of second mask support portions are adjustable.

2. The screen mask support frame according to claim 1, wherein the pair of first mask support portions is attachable to the frame member via spacers.

3. The screen mask support frame according to claim 1, wherein the first mask support portion includes a placement surface on which the first two sides in the outer frame of the screen mask are placed, and a pressing member configured to change between an advanced state in which the pressing member is advanced to an inside of the frame member and a retracted state in which the pressing member is retracted from the inside of the frame member, the pressing member being configured to press the outer frame of the screen mask placed on the placement surface against the placement surface in the advanced state.

4. The screen mask support frame according to claim 1,
wherein the pair of first mask support portions includes placement surfaces on which the first two sides in the outer frame of the screen mask is placed, and
the pair of second mask support portions is configured to be in contact with and support side surfaces of the second two sides in the outer frame of the screen mask.

5. The screen mask support frame according to claim 4, wherein a first one of the pair of second mask support members is provided with a biasing member configured to press the outer frame of the screen mask from the one of the pair of second mask support portions toward a second one of the pair of second mask support members.

6. A printer for printing viscous fluid on a target object using a screen mask with a mask main body fixed to an outer frame, the printer comprising:
a pair of rails extending in a printing region;
a screen mask supported by a screen mask support frame including a frame member having a size disposable in the pair of rails, a pair of first mask support portions provided on inner sides of first two sides, which face each other, in the frame member, the pair of first mask support portions being configured to support first two sides, which face each other, in the outer frame of the screen mask, and the pair of second mask support portions provided on inner sides of second two sides orthogonal to the first two sides in the frame member, a pair of second mask support portions being configured to laterally support second two sides orthogonal to the first two sides of the outer frame in the screen mask, in which an interval between the pair of first mask support portions and an interval between the pair of second mask support portions are adjustable;
a detection sensor configured to detect presence or absence of an interfering object between the pair of rails;
a contact section disposed above the pair of rails;
a lifting and lowering section configured to lift and lower the contact section;
a moving section configured to move the contact section along an extending direction of the pair of rails; and
a control section configured to control the lifting and lowering section such that the contact section is lowered, in a state in which an interfering portion of the screen mask support frame has not been detected below the contact section by the detection sensor, and then control the moving section such that the contact section moves in the extending direction, in a state in which the contact section has been lowered.
